(19) United States
(12) Patent Application Publication
(10) Pub. No.: US 2014/0083125 A1
(43) Pub. Date: Mar. 27, 2014

(54) WIND-POWERED FRESH WATER GENERATOR

(71) Applicant: Meng-Chyang PENG, Taipei City (TW)

(72) Inventor: Meng-Chyang PENG, Taipei City (TW)

(21) Appl. No.: 14/021,131

(22) Filed: Sep. 9, 2013

(30) Foreign Application Priority Data
Sep. 10, 2012 (CN) 201210333039.6

(51) Int. Cl. B01D 5/00

(52) U.S. Cl. CPC B01D 5/009
USPC 62/291; 62/331

(57) ABSTRACT

A wind-powered fresh water generator is provided. The wind-powered fresh water generator includes a wind rotation module disposed on a beam, a cooling and fresh water generating module connected to the wind rotation module, and a water collecting system disposed below the cooling and fresh water generating module. The wind-powered rotation module provides a rotation motive power to the cooling and fresh water generating module. The water generated by the cooling and fresh water generating module is collected by the water collecting system.

### RELATED APPLICATIONS

This application claims priority to China Application Serial Number 201210333039.6, filed Sep. 10, 2012, which is herein incorporated by reference.

### BACKGROUND

1. Field of Invention

The invention relates to an apparatus for generating fresh water. More particularly the invention relates to a wind-powered fresh water generator that uses wind power as the energy source for a cooling and fresh water generating module.

2. Description of Related Art

Arid regions are characterized by a severe shortage of available water and also typically by high temperatures. Therefore water resources are very important in such areas. Thus, an urgent problem that needs to be addressed is how to provide more water in arid regions.

A common way to ensure a supply of water involves building a reservoir to collect running water in rivers and rainwater. However, the level of precipitation in arid regions is low, and so the amount of running water in rivers and rainwater is limited. As a result, the water in the reservoir of an arid region is insufficient and in fact often there is no water therein. In some areas, there is no river available for supplying water for a reservoir.

As is well known, the cooling and fresh water generating module of an air-conditioning apparatus can generate water during operation. The cooling and fresh water generating module includes a compressor, a condenser, an expansion valve and an evaporator that are connected in a loop through a pipeline. The interior of the pipeline is filled with a coolant. The coolant is compressed, condensed, expanded and evaporated, so that the evaporator is cooled, and water vapor in the air is condensed into water when passing across the cold evaporator.

The cooling and fresh water generating module needs electric power or some form of rotational motive power for operation. If the cooling and fresh water generating module is used as a means to obtain water, electric power or rotational motive power must be continuously provided to the cooling and fresh water generating module. This results in high costs associated with the electric power or rotational motive power cost. In fact, the high costs exceed the benefit of the recovery of water. Moreover, since arid regions are usually located in remote places, the mounting and maintaining of electric power transmission and distribution lines are not easy and the costs are high, making the provision of electric power or rotational motive power to the cooling and fresh water generating module difficult and impractical. The problem of a lack of water in arid regions remains.

### SUMMARY

The invention provides a wind-powered fresh water generator that uses wind power as the energy source for a cooling and fresh water generating module.

An aspect of the invention provides a wind-powered fresh water generator including a wind rotation module disposed on a beam, a cooling and fresh water generating module connected to the wind rotation module, and a water collecting system disposed below the cooling and fresh water generating module. The wind rotation module provides a rotation motive power to the cooling and fresh water generating module. The water generated by the cooling and fresh water generating module is collected by the water collecting system. This is useful for providing water in arid regions. Through use of the wind-powered fresh water generator, the difficulties and costs associated with mounting and maintaining long-distance transmission and distribution lines can be avoided.

According to an embodiment of the invention, the wind rotation module includes a housing disposed on the beam; a speed-changing gear assembly disposed in the interior of the housing, in which the speed-changing gear assembly has a power output shaft; and a rotating assembly having a rotating shaft and plural blades disposed at the periphery of the rotating shaft, in which the rotating shaft is coupled to the speed-changing gear assembly. The rotating assembly is operated to rotate by wind, and a rotation motive power is provided to the cooling and fresh water generating module through the speed-changing gear assembly.

According to an embodiment of the invention, the cooling and fresh water generating module includes a compressor, a condenser, an expansion valve and an evaporator that are connected in a loop through a pipeline. The interior of the pipeline is filled with a coolant, and the compressor is connected to the power output shaft of the speed-changing gear assembly. The coolant is compressed, condensed, expanded and evaporated, so that the evaporator is cooled, and water vapor in the air can be condensed into water when passing across the cold evaporator. The water forms into water drops.

According to an embodiment of the invention, the compressor and expansion valve are disposed in the interior of the housing, and the condenser and the evaporator are disposed to the exterior of the housing. Through this configuration, the condenser easily dissipates heat and the evaporator easily contacts with external water vapor.

According to another embodiment of the invention, the compressor, expansion valve, condenser and evaporator are disposed in the interior of the housing, and a first port and second port are respectively disposed at positions of the housing corresponding to the condenser and evaporator. The first and second ports are used respectively as a heat dissipation passage of the condenser and a passage for the external water vapor contacting with the evaporator.

According to an embodiment of the invention, the water collecting system includes a water-collecting tray and a water conduit. The water-collecting tray is disposed below the evaporator. The water conduit has a water inlet section and water outlet section opposite to each other. The water inlet section is connected to the bottom of the water-collecting tray and communicated with the water-collecting tray. Thus, the water drops that drip from the evaporator are collected.

According to an embodiment of the invention, the housing is pivoted on the beam. The water collecting system further includes a water collecting tank which is disposed on the beam and located in the path that the water conduit passes through, so as to communicate with the water conduit. When the wind rotation module is configured to rotate with the wind direction, only the water inlet section of the water conduit is rotated, and the water generated by the evaporator is stored in the water collecting tank. The water outlet section of the water conduit does not rotate along with the wind rotation module according to the wind direction.

According to an embodiment of the invention, the water collecting system further includes a catch basin. The catch basin is located at the water outlet section of the water conduit, and is disposed on the ground. The water in the water-collecting tray is directed into the catch basin located on the ground along the water conduit, so as to facilitate the use of water.

### BRIEF DESCRIPTION OF THE DRAWINGS

In order to make the foregoing as well as other aspects, features, advantages and embodiments of the invention more apparent, the accompanying drawings are described as follows:

FIG. 1 is a perspective view of a wind-powered fresh water generator according to an embodiment of the invention;

FIG. 2 is a perspective view of the wind-powered fresh water generator shown in FIG. 1, in which part of a housing of a wind rotation module of the wind-powered fresh water generator has been removed;

FIG. 3 is a side sectional view of the wind-powered fresh water generator shown in FIG. 1; and

FIG. 4 is a top sectional view of the wind-powered fresh water generator shown in FIG. 1.

### DETAILED DESCRIPTION

The foregoing and other technical contents, features and functions of the invention will be clearly shown in the following detailed description of embodiments with reference to the accompanying drawings.

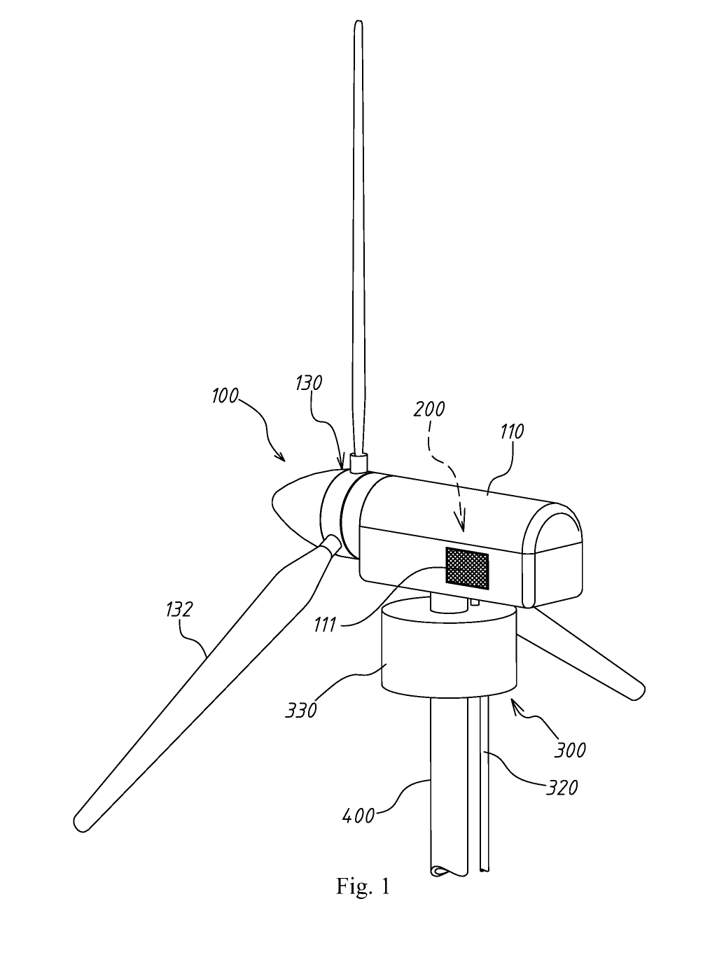

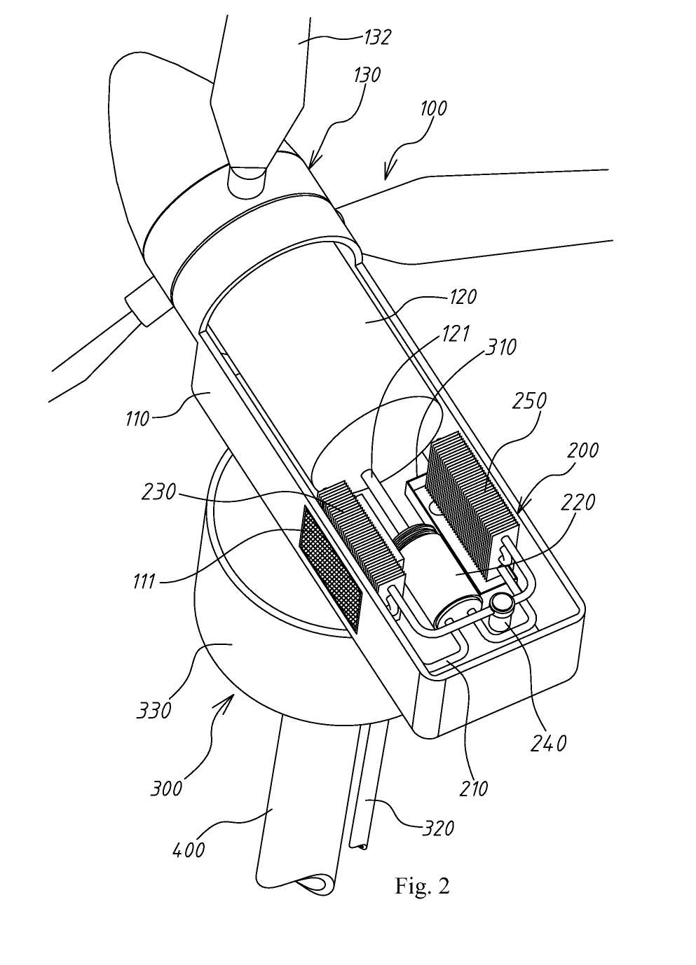

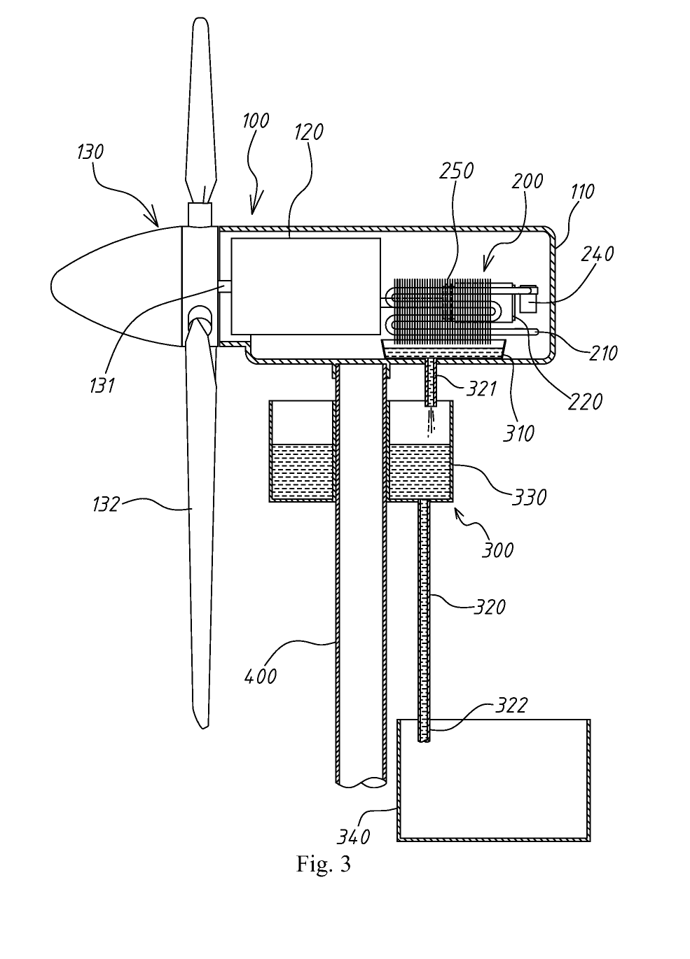

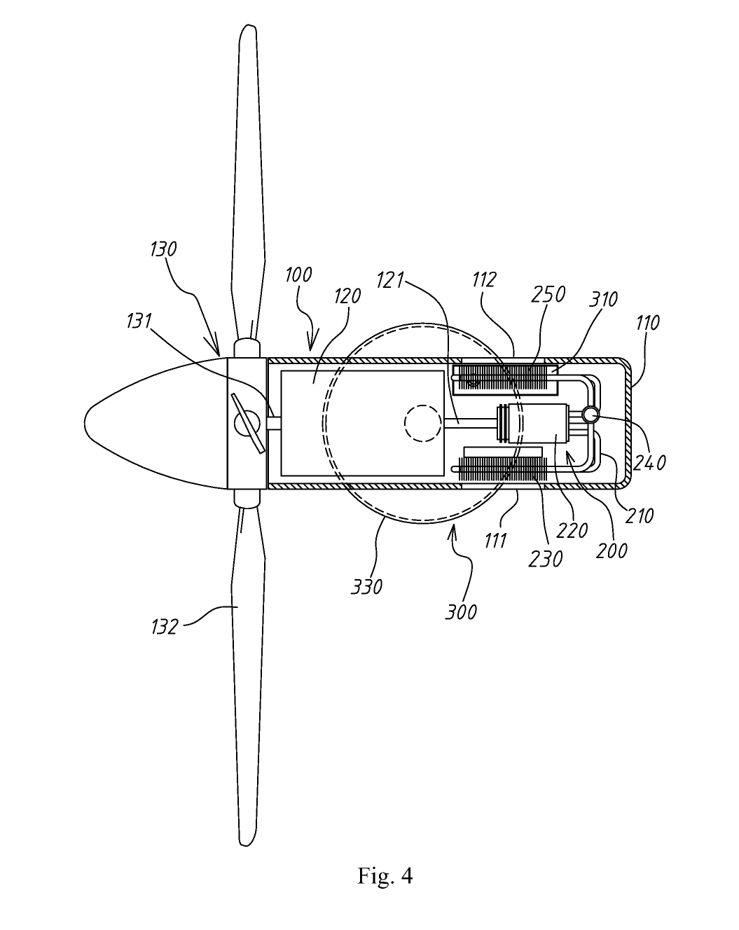

Referring to FIGS. 1-4, a wind-powered fresh water generator according to an embodiment of the invention includes a wind rotation module 100, a cooling and fresh water generating module 200 and a water collecting system 300.

The wind rotation module 100 is a wind rotation and speed-changing mechanism which includes a housing 110, a speed-changing gear assembly 120 and a rotating assembly 130. The housing 110 is disposed at an upper portion of a vertical beam 400, so that the wind rotation module 100 is able to receive a large amount of wind. In some embodiments, the housing 110 is pivoted on the beam 400, so that the direction of the wind rotation module 100 can be adjusted along with the wind direction, thereby ensuring that a maximum amount of wind is received by the wind rotation module 100. The speed-changing gear assembly 120 is disposed in the interior of the housing 110. The speed-changing gear assembly 120 is a speed-changing assembly comprising plural large and small gearwheels (not shown) engaged sequentially. The speed-changing gear assembly 120 has a power output shaft 121 extending to the exterior of the remainder of the speed-changing gear assembly 120. The rotating assembly 130 has a rotating shaft 131 and plural blades 132 disposed on the periphery of the rotating shaft 131. The rotating shaft 131 is coupled to the speed-changing gear assembly 120. When the rotating assembly 130 rotates by capturing wind power, the rotating assembly 130 drives the speed-changing gear assembly 120 to rotate at a high speed and thereby generate rotational motive power. The rotational motive power is provided to the cooling and fresh water generating module 200 through the power output shaft 121

The cooling and fresh water generating module 200 is an air-conditioning mechanism which includes a compressor 220, a condenser 230, an expansion valve 240 and an evaporator 250 that are connected in a loop through a pipeline 210. The compressor 220 is connected to the power output shaft 121 of the speed-changing gear assembly 120. The compressor 220 is driven to rotate by the rotational motive power provided by the power output shaft 121. The interior of the pipeline 210 is filled with a coolant (not shown). The properties of the coolant are such that when it is changed from a gas state to a liquid state, a large amount of heat is discharged, and when it is changed from a liquid state to a gas state, a large amount of heat is absorbed.

During operation of the cooling and fresh water generating module 200, the compressor 220 compresses the gaseous coolant into a high temperature and high pressure gaseous state, and then a normal temperature and high pressure liquid coolant is formed after the high temperature and high pressure gaseous coolant is conveyed to the condenser 230 to undergo heat dissipation therein. Subsequently, the coolant is conveyed to the expansion valve 240 and enters the evaporator 250. When the coolant reaches the evaporator 250 from the expansion valve 240, since the space is suddenly enlarged and the pressure is decreased, the liquid coolant is gasified into a gaseous and low temperature coolant, thereby absorbing a large amount of heat. As a consequence, the evaporator 250 is cooled, and the water vapor in the air is condensed into water after passing across the cold evaporator 250. The water forms into water drops on the surface of the evaporator 250.

In the embodiment, the compressor 220 and the expansion valve 240 may be disposed in the interior of the housing 110, and the condenser 230 and the evaporator 250 may be disposed either to the exterior or in the interior of the housing 110. When the condenser 230 and the evaporator 250 are disposed to the exterior of the housing 110, the condenser 230 may easily dissipate heat, and the evaporator 250 is exposed to allow for easy contact with external water vapor. When the condenser 230 and the evaporator 250 are disposed in the interior of the housing 110, a first port 111 and a second port 112 are respectively disposed at positions of the housing 110 corresponding to the condenser 230 and the evaporator 250. With such a configuration, the first port 111 and the second port 112 are respectively used as a heat dissipation passage of the condenser 230 and a contact passage for the evaporator 250 (i.e., to allow external water vapor to contact the evaporator 250).

The water collecting system 300 is disposed below the cooling and fresh water generating module 200. The water collecting system 300 includes a water-collecting tray 310, a water conduit 320, a water collecting tank 330 and a catch basin 340. The water-collecting tray 310 is disposed below the evaporator 250 for collecting the water drops formed on and that drip from the evaporator 250. The water conduit 320 has a water inlet section 321 and a water outlet section 322 opposite to each other. The water inlet section 321 is connected to the bottom of the water-collecting tray 310 and is communicated with the water-collecting tray 310. The water inlet section 321 is used for allowing the water collected by the water-collecting tray 310 to flow out from the same and into the water collecting tank 330. The water outlet section 322 is connected to the bottom of the water collecting tank 330 and is communicated with the water collecting tank 330. The water outlet section 322 is used for allowing the water collected by the water collecting tank 330 to flow out from the same and into the catch basin 340. The catch basin 340 is located at a lower end of the water outlet section 322 of the water conduit 320, and is placed on the ground.

Through this configuration of the water collecting system 300, the water in the water-collecting tray 310 is transferred through the water conduit 320 to the catch basin 340 located on the ground, so as to facilitate use of the water. When plural wind-powered fresh water generators are used, the catch basins 340 respectively thereof may be communicated with a large-scale reservoir (not shown), so that a large amount of water may be stored at a single location.

The water collecting tank 330 is disposed on the beam 400 and located in the path that the water conduit 320 passes through, so as to communicate with the water conduit 320. When the wind rotation module 100 is configured to follow the wind direction, as described above, only the water inlet section 321 is rotated, and the water generated by the evaporator 250 is transferred to the water collecting tank 330 for storage therein through the water inlet section 321. Moreover, at this time, the water outlet section 322 does not move along with the wind rotation module 100 according to the wind direction, and in such an immobile state, functions to lead the water in the collecting tank 330 out into the catch basin 340 which is located at a set location.

In the wind-powered fresh water generator according to an embodiment of the invention, the wind rotation module 100 provides a rotational motive power to the cooling and fresh water generating module 200, and the water generated by the cooling and fresh water generating module 200 is effectively collected by the water collecting system 300. Hence, water can be generated, and this may be particularly useful for arid regions. Since arid regions are usually located in remote areas with few obstructions, the wind rotation module 100 can capture a sufficient amount of wind to generate the rotational motive power, and thereby continuously supply the rotational motive power required by the cooling and fresh water generating module 200 for operation. Hence, the high costs associated with having to provide electric power or rotational motive power cost may be avoided, as can the difficulties associated with mounting and maintaining long-distance transmission and distribution lines.

Although the invention has been disclosed with reference to the above embodiments, these embodiments are not intended to limit the invention. Those of skills in the art can make various variations and modifications without departing from the spirit and scope of the invention. Thus, the scope of the invention should be defined by the appended claims.

What is claimed is:

1. A wind-powered fresh water generator, comprising:
a wind rotation module disposed on a beam;
a cooling and fresh water generating module connected to the wind rotation module; and
a water collecting system disposed below the cooling and fresh water generating module.

2. The wind-powered fresh water generator of claim 1, wherein the wind rotation module comprises:
a housing disposed on the beam;
a speed-changing gear assembly disposed in the interior of the housing, wherein the speed-changing gear assembly has a power output shaft; and
a rotating assembly having a rotating shaft and plural blades disposed at the periphery of the rotating shaft, wherein the rotating shaft is coupled to the speed-changing gear assembly.

3. The wind-powered fresh water generator of claim 2, wherein the cooling and fresh water generating module comprises a compressor, a condenser, an expansion valve and an evaporator that are connected in a loop through a pipeline, the interior of the pipeline is filled with a coolant, and the compressor is connected to the power output shaft of the speed-changing gear assembly.

4. The wind-powered fresh water generator of claim 3, wherein the compressor and the expansion valve are disposed in the interior of the housing, and the condenser and the evaporator are disposed to the exterior of the housing.

5. The wind-powered fresh water generator of claim 3, wherein the compressor, the expansion valve, the condenser and the evaporator are disposed in the interior of the housing, and a first port and a second port are respectively disposed at positions of the housing corresponding to the condenser and the evaporator.

6. The wind-powered fresh water generator of claim 3, wherein the water collecting system comprises a water-collecting tray and a water conduit, the water-collecting tray is located below the evaporator, the water conduit has a water inlet section and a water outlet section opposite to each other, and the water inlet section is disposed at the bottom of the water-collecting tray and communicated with the water-collecting tray.

7. The wind-powered fresh water generator of claim 6, wherein the housing is pivoted on the beam, the water collecting system further comprises a water collecting tank, and the water collecting tank is disposed on the beam and located in the path that the water conduit passes through, so as to communicate with the water conduit.

8. The wind-powered fresh water generator of claim 7, wherein the water collecting system further comprises a catch basin, and the catch basin is located at the water outlet section of the water conduit and disposed on the ground.

9. The wind-powered fresh water generator of claim 6, wherein the water collecting system further comprises a catch basin, and the catch basin is located at the water outlet section of the water conduit and disposed on the ground.
